(19) United States
(12) Patent Application Publication
(10) Pub. No.: US 2010/0138774 A1
(43) Pub. Date: Jun. 3, 2010

(54) SYSTEM AND METHOD FOR PROCESSING FLOW CYTOMETRY DATA

(76) Inventors: Nicholas Daryl Crosbie, Victoria (AU); Vittorio Cordioli, Victoria (AU)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/447,532

(22) PCT Filed: Oct. 30, 2007
(86) PCT No.: PCT/AU07/01645

§ 371 Date: Feb. 11, 2010

Related U.S. Application Data
(60) Provisional application No. 60/863,602, filed on Oct. 31, 2006.

(51) Int. Cl. G06F 9/305; G06F 3/048

(52) U.S. Cl. 715/780; 712/223; 715/853; 712/E09.018

(57) ABSTRACT

A computer-implemented method for processing multivariate data, comprising: inputting or receiving an alphanumeric expression comprising at least one process pointer, indicative of a gating process, a Boolean process or an external process; parsing the expression; executing the process indicated by the process pointer on multivariate data in a data file; and outputting output data comprising the multivariate data processed according to the expression.

### FIELD OF THE INVENTION

The present invention relates to a system and method for processing multivariate data, particularly highly multivariate data such as flow cytometry data.

### BACKGROUND OF THE INVENTION

Recent advances in flow cytometry hardware, together with the commercial availability of a large number of fluorochromes, has led to the development of up to 17-color flow cytometry. The analysis of the complex data sets generated by this technology, however, is severely constrained by existing analysis software. In current software analyses, gating (effecting a sub-setting action) a population or populations of interest in bivariate dot plots (‘bivariate gating’) is followed by further bivariate plotting of cells belonging to the gated population or populations. After a number of bivariate gating actions, populations of interest are usually not sub-gated further. Instead, multiple parameters are juxtaposed against the same reference parameter in consecutive dot plots. From this point on, the information gathered increases linearly with the number of parameters, but the true information content of the data increases exponentially with the number of parameters, so potentially important information may be ignored.

One existing approach for analysing highly multivariate flow cytometry data employs automated classification techniques, but the comparison of replicates of multiple experimental groups is problematic owing to the high computational intensity of these techniques. A large reduction in computation can be achieved by first manually gating populations and then applying multivariate analyses to derived statistics. This approach can facilitate successful data analysis, but the number and complexity of the manual gating steps imposes a considerable burden on the person performing the analysis.

### SUMMARY OF THE INVENTION

According to a first broad aspect, the present invention provides a computer-implemented method for processing multivariate data (especially highly multivariate data such as flow cytometry data), comprising:
inputting or receiving an alphanumeric expression comprising at least one process pointer, indicative of a gating process (termed a simple process), a Boolean process or an external process (termed complex processes);
parsing the expression;
executing the process indicated by the process pointer on multivariate data (such as flow cytometry data) in a data file; and
outputting output data comprising the multivariate data processed according to the expression.

The method may include associating the alphanumeric expression with the data file.

Associating the alphanumeric expression with the data file of multivariate data can be done in a number of ways. In one embodiment, the method comprises inputting in the alphanumeric expression at least one data file pointer indicative of the data file. In another embodiment, the method includes inputting the alphanumeric expression in a data entry field visually associated with (such as located beside) a data file indicium (such as an icon) indicative of the data file. In the latter example, the method may include displaying the data file indicium in a visual representation of a file system (comprising, for example, a tree in which the data file and other like data files are represented as nodes of the tree).

The method may include displaying an indicium indicative of the data file and the alphanumeric expression as a tree, the data file being displayed at a node of the tree and the alphanumeric expression being displayed inferior to the node. In particular, in embodiments that include a plurality of data files each associated with one or more respective alphanumeric expressions, the method may include displaying respective indicia indicative of the data files and the alphanumeric expressions as a tree, each of the data files being displayed at respective nodes of the tree and each of the alphanumeric expressions being displayed inferior to the respective node of its corresponding data file.

The method can be used to reduce the burden of manual gating operations such as those involved in the software analysis of multivariate data (such as flow cytometric data), and allows semi-automated gating procedures and batch processing routines to be easily constructed and to benefit from dynamic access to information—stored in the application's persistent documents or held externally—for the purpose of amending, pausing or recommencing a gating procedure(s) or batch processing routine(s) during an analysis session. The alphanumeric expression may be compact, highly portable, understood by the experienced user with little difficulty, and immediately available for, and well suited to, textual filtering processes, such as those involving wild cards or regular expressions.

The expression may comprise a plurality of data file pointers, each indicative of a respective data file of multivariate data to be processed by the process indicated by the process pointer. Typically the expression comprises a plurality of process pointers, each indicative of a respective gating process, Boolean process or external process. In one embodiment, the method includes separating each pair of process pointers in the expression with a process separator comprising an alphanumeric character (such as a comma).

The method may include separating the data file pointer from the at least one process pointer with an alphanumeric character (such as a colon).

Alternatively, the method may include entering the data file pointer and the at least one process pointer in separate fields of a user interface (thereby separating them).

In certain embodiments, the method includes inputting a plurality of alphanumeric expressions in respective data entry fields visually associated with respective data file indicia, each indicative of a respective data file of multivariate data.

The method typically includes processing the expression from left to right. However, the method may include specifying a higher order of precedence of one portion of the expression over a second portion of the expression (such as by placing the first portion in round brackets or parentheses).

In one embodiment, the expression includes at least one watch point for initiating testing of a predefined condition, and indicated in the expression relative to one or more process pointers (such as by bracketing the one or more process pointers, for example with square brackets, or changing the case of the one or more process pointers, for example from lower case to upper case). The method may include responding when the condition yields true by continuing to evaluate the expression without user interaction, and responding when the condition yields false by performing a predefined response (such as launching a context-dependent graph). The response may include an instruction to continue processing the remainder of the expression.

The method may include parsing the expression with a parser, such as an LALR or recursive descent parser. The method may include generating a script for an inter-process communication scripting language, a standard scripting language (such as JavaScript), or a special-purpose scripting language, such as R, with a parser (such as such as an LALR or recursive descent parser).

When the, alphanumeric expression is indicative of one or more Boolean processes, parsing the alphanumeric expression includes returning at least one intermedia result set, and outputting the intermedia result set or making the intermedia result set available to a user.

According to a second broad aspect, the present invention provides a system for processing multivariate data (such as flow cytometry data), comprising:
an input for receiving an alphanumeric expression comprising at least one process pointer, indicative of a gating process (termed a simple process), a Boolean process or an external process (termed complex processes);
a parsing module for parsing the expression; a processor for evaluating the expression by executing the process indicated by the process pointer on the multivariate data in the data file; and
an output for outputting data comprising the multivariate data processed according to the expression.

The system may include a mechanism for associating the alphanumeric expression with the data file.

The mechanism may be configured to associate the alphanumeric expression with the data file in a number of ways. In one embodiment, the input is configured to receive in the alphanumeric expression at least one data file pointer indicative of the data file. In another embodiment, the input includes a display and is configured to provide a data entry field for receiving the alphanumeric expression, the data entry field being associated in the display with a data file indicium (such as an icon) indicative of the data file. In the latter example, the system may be configured to display the data file indicium in a visual representation of a file system of the system (comprising, for example, a tree in which the data file and other like data files are represented as nodes of the tree).

According to another aspect, the present invention provides a computer-implemented method of processing multivariate data (such as flow cytometry data), comprising:
inputting into a first computing device an alphanumeric expression comprising at least one process pointer, indicative of a gating process, a Boolean process or an external process;
electronically dispatching the expression to a second computing device;
receiving from the second computing device response data comprising multivariate data processed according to the expression once parsed by the execution of the process indicated by the process pointer on original cytometry data in a data file; and
outputting response data.

In one embodiment, the method may include associating the alphanumeric expression with a data file of the original multivariate data.

In one embodiment, the method includes electronically dispatching the data file to the computing system.

According to another aspect, the invention provides a computer readable medium provided with program data that, when executed on a computing device or system, controls the device or system to perform any one or more of the methods for processing multivariate data described above.

### BRIEF DESCRIPTION OF THE DRAWING

In order that the invention may be more clearly ascertained, embodiments will now be described, by way of example, with reference to the accompanying drawing, in which:

FIG. 1 is a schematic view of a system for processing flow cytometry data according to an embodiment of the present invention;

FIG. 2A is a view of an exemplary worksheet table of the system of FIG. 1;

FIG. 2B is a view of a exemplary worksheet according to an alternative embodiment, for inputting and organizing the alphanumeric expressions of the system of FIG. 1;

FIG. 3 illustrates the relationship between a Gate Entity and a worksheet row in the system of FIG. 1;

FIG. 4 is a view of an exemplary Boolean Gates table of the system of FIG. 1;

FIGS. 5A and 5B are views of an exemplary dotplot graph#1 of the system of FIG. 1;

FIG. 6 is a view of an exemplary marker graph of the system of FIG. 1;

FIGS. 7A and 7B illustrate the flow cytometry gating language of the system of FIG. 1;

FIG. 8 is a Set Expression Framework UML Class diagram for the system of FIG. 1;

FIG. 9 is the LALR(1) parser grammar specification for the SetExpression framework of the system of FIG. 1; and

FIG. 10 illustrates the Nested Object Specifiers that facilitate reference of a gate object via an OSA-compliant script in the system of FIG. 1.

### DETAILED DESCRIPTION OF THE EMBODIMENTS

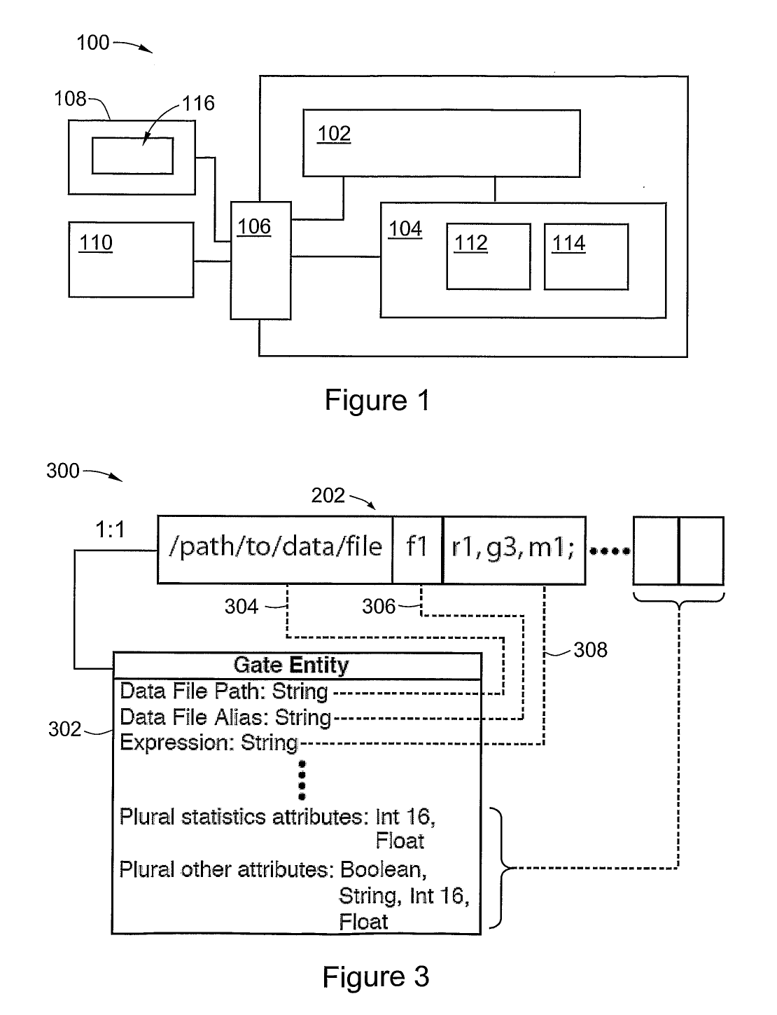

A system for processing multivariate data in the form of flow cytometry data according to an embodiment of the present invention is shown schematically at 100 in FIG. 1. System 100 includes a processor 102, a memory 104, an I/O device 106 (which includes USB ports), a display 108 and a user input 110 (including a keyboard and mouse) by means of which a user can control system 100. Memory 104 (which comprises RAM, ROM and a hard-disk drive) includes an operating system 112 (in this embodiment, Apple Macintosh (trade mark) OS X) and a flow cytometry data processing software 114, each having executable components that can be executed by processor 102. Processing software 114, under user control, is adapted to control system 100 to perform the functions described below, including generating a graphical user interface (GUI) 116 on display 108 with which the user can interact (with the aid of user input 110), from which processing software 114 can receive input and to which processing software 114 display output.

The software and hardware components of system 100 provide the following functionality:

(i) GUI 116, principally comprising (a) document windows, each containing a worksheet table and a Boolean gates table, and (b) graph windows;

(ii) a domain-familiar gating language (defined in and adapted to control processing software 114), which includes gating expressions in conceptual blocks composed of singular sub-setting actions (the action of a single “region” or “marker” gate) and/or complex sub-setting actions (i.e. Boolean gates that typically reference and combine the action of plural region or marker gates and/or other Boolean gate(s));

(iii) the ability to create new expressions in the gating language by graphical interaction with a graph contained within a graphics window;

(iv) the ability to simplify Boolean gates with an implementation of the Quine-McCluskey algorithm linked to a GUI element;

(v) a gate cloning functionality linked to a GUI element;

(vi) the exposure of a certain important flow cytometry data analysis functionality, including “intermediate gating actions” that form part of a Boolean gate, to system-wide scriptability, by (a) providing the user the ability to define gate and expression aliases, and (b) adapting processing software 114 for Open Scripting Architecture (OSA)-compliant scriptability.

As mentioned above, processing software 114 defines and can be controlled by a gating language, which can be used to specify batch processing routines for flow cytometry data processing and analysis. A user can compose, save and manipulate expressions in this language to control system 100 to perform the desired data processing. Though discussed in greater detail below, to illustrate this approach one may consider the following exemplary expression in this language:

f1-f7: g1(r1, [r2], r3), [e1], r4;

This exemplary expression has three basic elements:

(i) data file symbolic pointers (viz. f1-f7), which point to the data file(s) of flow cytometry data on which the expression proper (i.e. the non-data file components) should act, and may be separated from the expression proper by a colon or by being placed in separate fields of GUI 116.

(ii) process symbolic pointers and syntax (viz. g1, r1, r2, r3, e1, and r4), with which processes (whether ‘simple’ or ‘complex’ as discussed below) are specified.

In the example, g1 and e1 are pointers to complex processes. g1 refers to a Boolean process (in domain-familiar syntax); e1 refers to an ‘external’ process, such as a pointer to a cluster analysis engine. Boolean processes are encoded (as strings) separately using domain-familiar syntax. Watch points (described below) may be placed on individual operations contained within Boolean processes.

r1, r2, r3 and r4 are each simple gating processes.

Sequential operations (e.g. deriving a subset, then deriving a subset from the resulting set, etc.) are separated by commas. Thus, the phrase ‘r1, [r2], r3′ may be translated as: the operation r2 derives a subset from that set resulting from the operation r1; this is then followed by the operation r3 which derives a subset from that set resulting from the operation r2.

Operations are evaluated left to right. Round brackets or parentheses, ( ) specify a higher order of precedence.

(iii) watch points, denoted by [ ] about a process symbolic pointer (e.g. [r2]) or the capitalization of a process symbolic pointer (e.g. R2 instead of r2). Watch points initiate the testing of a condition, where:
(a) if the condition yields true, the processing software 114 continues evaluating the expression without user interaction.
(b) if the condition yields false, the processing software 114 initiates a user-specified response (e.g. launch the context-appropriate graph). The response may include an instruction (typically entered by the user) to continue processing the remainder of the expression.

Watch point conditions and responses are entered separately; conditions may reference processes that may or may not be specified in the expression. For example, a test condition may refer to a statistical feature of a set derived from, say, an r5 operation applied to a matching control sample. Special file-file mapping (e.g. test-control files) are encoded (as strings) separately.

In this example the end of the expression is indicated with a semi-colon, but this is only required where ambiguity as to where the expression ends would otherwise arise.

It should be noted that the gating language is simple, yet allows a user to elegantly express potentially complex batch-processing routines. Watch points allow the user to implement quality control at each stage of an analysis. The gating expressions are easily archived, are a searchable form of metadata, are well-suited for use in situations where space and/or bandwidth is limited (e.g. web page, PDA, spreadsheet cell), and immediately available for, and well suited to, textual filtering processes, such as those involving wild cards or regular expressions.

Processing software 114 includes an LALR(1) parser that allows all possible expression combinations to be parsed in an efficient manner. Parsed expressions can be executed immediately or used to generate scripts for an inter-process communication scripting language, a standard scripting language (such as JavaScript (trade mark) or AppleScript (trade mark)), or a special-purpose scripting language, such as R.

The Worksheet Table

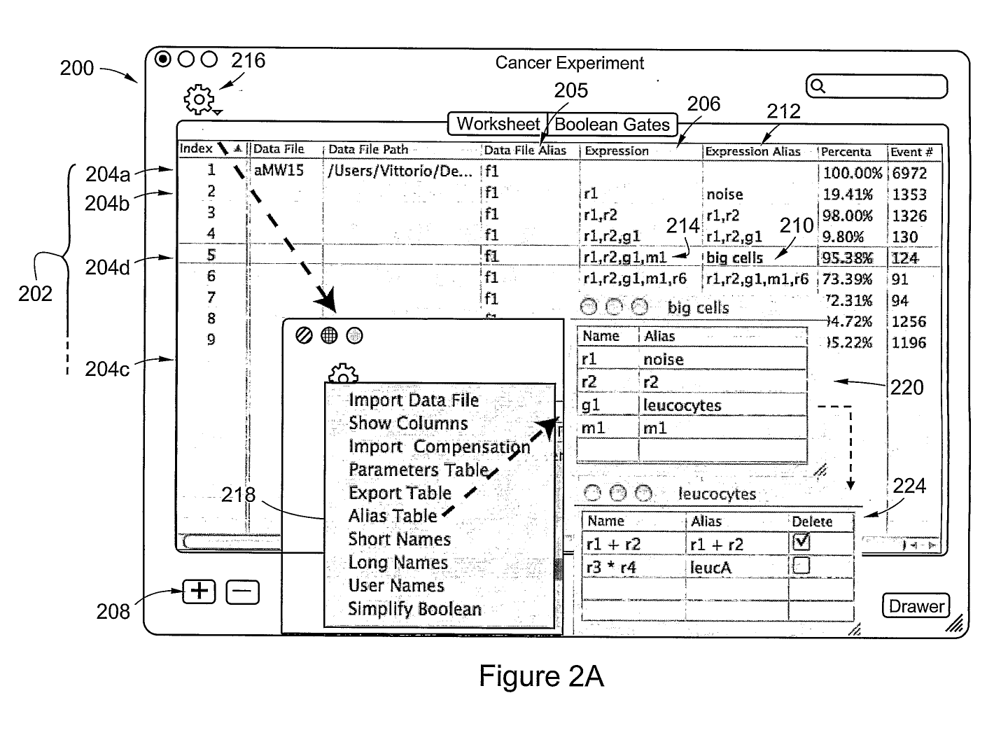

Processing software 114 is operable to display a “worksheet table” on GUI 116; FIG. 2A is view of an exemplary worksheet table 200 of system 100. Worksheet table 200 allows the user to progressively compose a batch processing expression, manipulate such expressions, and save them for later use.

Worksheet 200 has a plurality of worksheet rows 202; each worksheet row and its contents are mapped to a Gate Entity (GE). In this embodiment, data file pointers and process pointers are associated by being entered in separate columns of a GE (respectively at 205 and 206) of a single worksheet row 202; as they are entered into separate columns, however, the data file pointers and process pointers need not be further separated, whether by a colon or otherwise. Similarly, the requirement to terminate expressions with a semi-colon is relaxed.

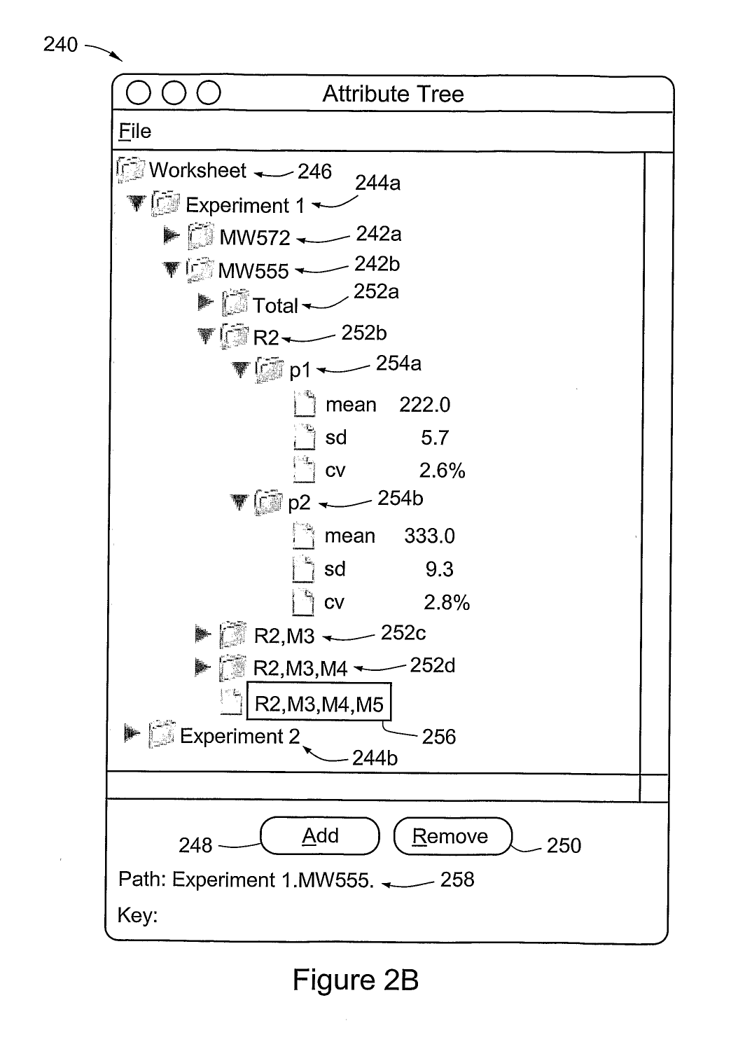

FIG. 3 illustrates at 300 both an exemplary GE 302 and the corresponding exemplary worksheet row 202, in one-to-one cardinality with each other. Columns within worksheet row 202 map the data attributes of GE 302, including the Data File Path attribute 304, Data File Alias attribute 306 and Expression attribute 308.

A GE can be classified into one of three fundamental types: (i) a Data File Gate Entity (DFGE) is a GE that contains legal non-nil content in its Data File Path attribute 304 and Data File Alias attribute 306, and nil content in its Expression attribute 308; (ii) an Expression Gate Entity (EGE) is a GE that contains legal non-nil content in its Data File Alias attribute 304 and Expression attribute 308, and (iii) a Spacer-Comment Object (SCE) is a GE that contains nil content in its Data File Path attribute 304, Data File Alias attribute 306 and Expression attribute 308 (see, for example, worksheet row 204c).

In an alternative embodiment, data files and process pointers are associated in a different manner. FIG. 2B is an exemplary screen-shot of a collapsible and expandable file system tree 240 as displayed on display 108 by system 100. File system tree 240 represents at least some of the cytology data files stored on system 100, each shown as a data file icon (e.g. data files MW572 at 242a and MW555 at 242b). In addition, tree 240 includes experiment icons 244a, 244b indicative of the respective experiments from which the cytology data was gathered; the experiment icons 244 are superior to their respective data file icons. Furthermore, tree 240 includes at least one Worksheet icon 246, which groups open or more experiments and is superior to icon or icons 244 indicative of those experiments.

Thus, in the illustrated example, Worksheet 246 includes experiment_1 244a and experiment_2 244b, and experiment_1 244a has associated data files 242a and 242b. The icon representing experiment_2 244b has not been expanded, so any data files associated with experiment_2 244b are not displayed.

If the user selects a data file icon (such as data file icons 242a, 242b), then clicks “Add” button 248, system 100 responds by displaying a data input field in a position inferior—in the tree—to that data file icon; the user can type or paste into that field one or more process pointers, indicative of gating, Boolean or external processes. If the user selects such a process pointer, then clicks “Add” button 248, a further data input field is displayed in a position inferior to that process pointer, into which one or more further process pointers can be typed or pasted by the user. Process pointers entered in this manner are associated by system 100 with the data file immediately superior in tree 240.

If the user selects a data file icon or a process pointer, then clicks “Remove” button 250, system 100 responds by removing that data file icon or a process pointer.

Thus, a tree of experiments, data files and process pointers can be represented in a tree format, and selectively expanded or collapsed for viewing or editing. When execution and hence evaluation should occur (i.e. of the process indicated by the sequence of process pointers inferior in the tree to the associated data file, on the flow cytometry data in that data file) is configurable by the user by operation of system 100. In one configuration, the entering of the process and its execution are coupled; that is, system 100 will attempt to parse and execute the process as soon as it has been entered by the user.

In a second user-selectable configuration, these two actions are uncoupled; the process is not automatically parsed and executed by system 100 immediately after being entered by the user, allowing the user to—for example—copy expressions from one file icon to another without their immediate invocation. In this configuration, the process is parsed and executed by system 100 only when the user controls system 100 to do so. The user may do this, according to various embodiments, in a number of ways. For example, in one embodiment, the user may select a process (or processes) with a mouse, right-click to prompt system 100 to display a menu of options, and—from that menu—select an “update expression” option. According to a preferred embodiment, an “update expression” button (not shown) is provided on the user interface, and activated once the user has selected one or more expressions with, for example, the mouse. The activation of the “update expression” menu option or button controls system 100 to update the selected expression or expressions, that is, execute the selected expression or expressions and display updated statistics (in the illustrated example), though not launch any graphs.

In addition, in each configuration, the user may double-click a node that contains an expression, and thereby prompt system 100 to both recalculate statistics and to display the appropriate graph or graphs.

In each such configuration, system 100 is configured to output the result to the display after the execution of the process.

For example, as shown in FIG. 2B, process pointers “Total” 252a, “R2” 252b, “R2,M3” 252c and “R2,M3,M4” 252d have been associated with data file MW555 242b. Process pointers “p1” 254a and “p2” 254b have been entered inferior to process pointer “R2” 252b. Process pointers “p1” 254a and “p2” 254b are illustrated expanded, such as would typically be the case immediately after they have been entered by the user. In addition, whether automatically or under user control, system 100 has parsed and executed the process indicated by the sequence of process pointers inferior to MW555 242b; as a consequence, system 100 is displaying outputs mean (=222.0), sd (=5.7) and cv (=2.6%) for “p1”, and outputs mean (=333.0), sd (=9.3) and cv (=2.8%) for “p2”.

As discussed above, selecting a data file or process pointer, then clicking on “Add” button 250, prompts system 100 to display an inferior data entry field. In FIG. 2B, this is shown as having just been done for data file MW555 242b; hence data entry field 256 has been displayed, into which the user has typed or pasted the sequence of process pointers “R2,M3,M4,M5”. The path of the data file with which associated process pointers are currently being edited or entered (in this example, “Experiment 1.MW555”) is indicated at 258.

A DFGE is created for each imported Flow Cytometry Standard file. GUI elements engaged in the selection of files may be standard Macintosh OS X API, and FCS parsing may be employed. The DFGE created for the first FCS file imported to a given document is assigned the string “f1” to its Data File Alias attribute 306. Thereafter, the value of the assigned Data File Alias is incremented by one (f2, f3, f4, . . . ) for each FCS file imported into a document. Multiple importing of the same FCS file is allowed and treated as though plural different FCS files had been imported. That is, the assigned Data File Alias is incremented by one each time the FCS file is imported.

The contents of a newly created DFGE automatically populates the next available worksheet row 202. Repositioning of that worksheet row 202 is permitted thereafter. The statistical attributes of each DFGE are automatically populated using the entire first DATA segment of its associated FCS file as input.

The user creates a new EGE with either of two methods: 1) graphical interaction with an existing DFGE or EGE, and 2) typing or pasting part or all of an expression string to a new editable worksheet row.

Method 1: Graphical Interaction with an Existing DFGE or EGE

The user double-clicks any non-editable cell belonging to a worksheet row 202 mapping an existing DFGE or EGE, such as worksheet rows 204a and 204b, respectively. This launches a graphics window housing graphs (such as a bivariate dotplot and a histogram) constructed from the entire first DATA segment of its associated FCS file (DFGE) or a subset thereof (EGE) (described below).

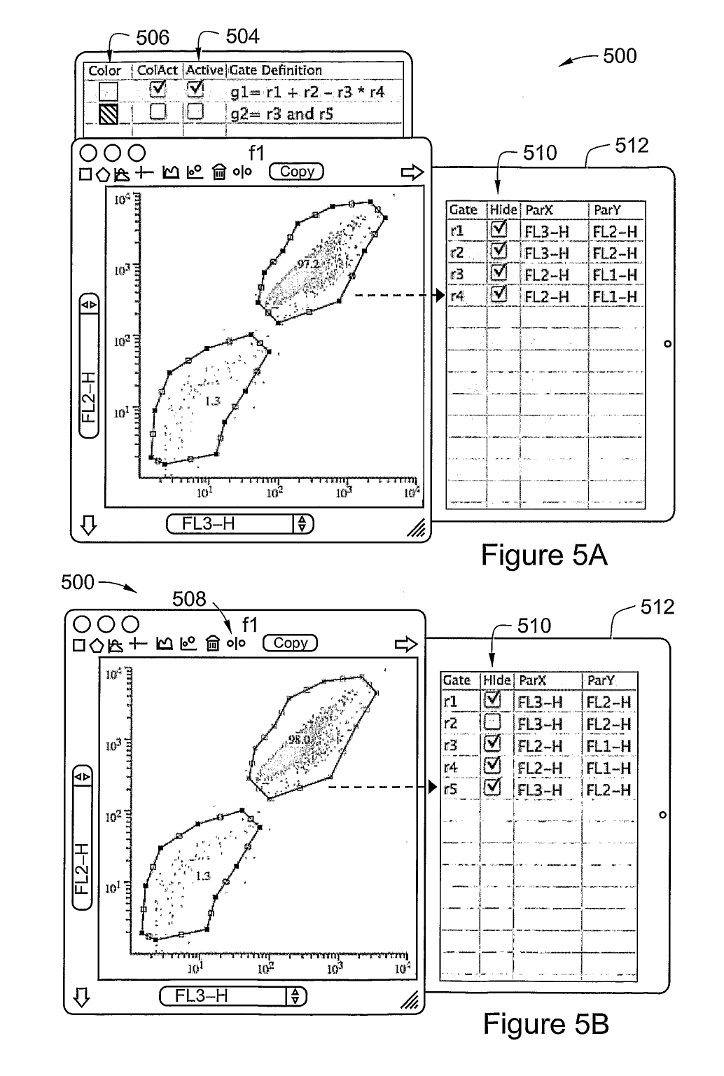

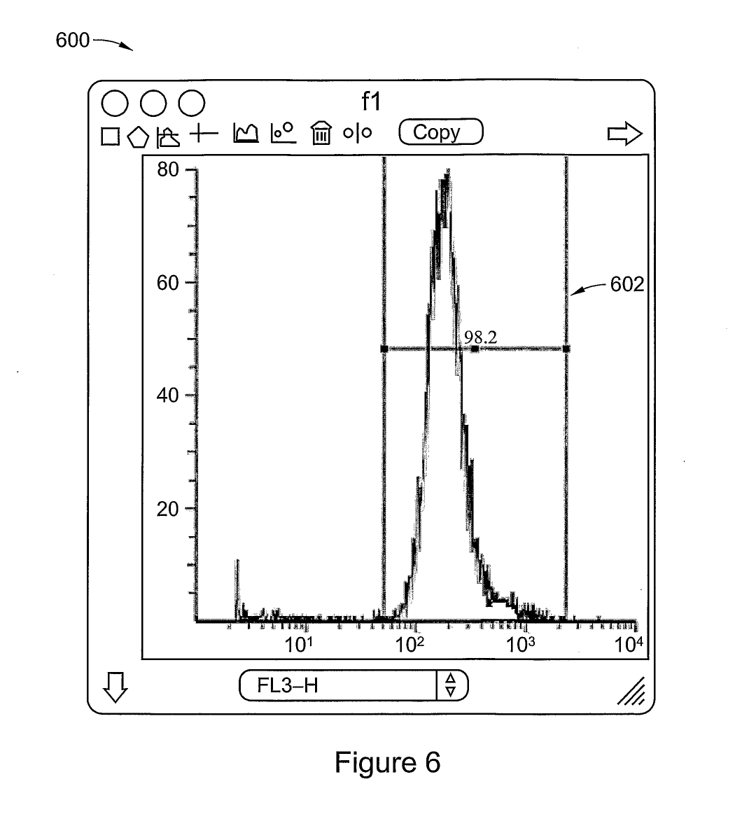

FIGS. 5A and 5B are views of an exemplary dotplot graph#1 500 generated by system 100, and FIG. 6 is a view of an exemplary marker graph 600 generated by system 100. By graphically interacting with the data and user interface elements contained within a DFGE- or EGE-associated graphics window, the user is able to adjust (or redefine) an existing “region” gate (shown at 502 in FIG. 5A) or “marker” gate (shown at 602 in FIG. 6), activate or deactivate a Boolean gate (with “Active” checkboxes 504 in FIG. 5A), or “clone” an existing region or marker gate.

If a new region or marker is defined, it is automatically assigned a Gate Name string: within a document, the first-defined region is assigned the string “r1” and the first-assigned marker is assigned the string “m1”. Region and marker numbers are incremented by one as each new region or marker is created (r2, r3, r4, rn; m2, m3, m4, mn).

A user activates a Boolean gate by selecting its associated “Active” checkbox 504 (in FIG. 5A); this applies that gate to the DFGE- or EGE-data set bound to the currently-selected (in-focus) graphics window. The Gate Name string of the activated gate is appended to the end of the expression belonging to the “parent” DFGE or EGE. The expression string thus extended and contents of the Data File Alias attribute 306 of the “parent” DFGE or EGE are written to the Expression attribute 308 and Data File Alias attribute 306, respectively, of a newly created EGE. The contents of the newly created EGE, including calculated statistics, automatically populate the next available worksheet row 202. Repositioning of that worksheet row is permitted thereafter. Deactivating a Boolean gate (by the user deselecting its associated “Active” checkbox 504) causes the deletion of the EGE to which it had been applied.

The user may also toggle Boolean gate color on/off, with Color checkbox 506.

The gate “cloning” functionality and associated GUI elements provides the user with the ability to easily make fine adjustments to an existing gating procedure, as an existing gate is used as a template. Cloning a region or marker gate will reproduce it, assign the next available number to the cloned gate's Gate Name, and locally (i.e. within the context of the current graph) hide the “parent” region or marker. The user effects a clone by selecting the target region or marker gate with the right mouse button, then clicking on the “clone” icon (shown at 508 in FIG. 5B) with the left mouse button. During gate cloning, a GUI element (in the form of a “hide” checkbox 510 in side drawer 512 of FIGS. 5A and 5B) is automatically toggled to “hide” for the template (parent) gate. That gate may be made visible again by the user graphically interacting with the aforementioned GUI element (in this example, by unchecking the respective checkbox).

In a manner equivalent to that already described for activated Boolean gates, the Gate Name string of a new region or marker gate or of a cloned gate is appended to the end of the expression belonging to the “parent” DFGE or EGE. The expression string thus extended and the contents of the Data File Alias attribute 306 of the “parent” DFGE or EGE are written to the Expression attribute 308 and Data File Alias attribute 306, respectively, of a newly created EGE. The contents of the newly created EGE, including calculated statistics, automatically populate the next available worksheet row 202, and thereafter repositioning of that worksheet row 202 is permitted. The full definition of a newly created region or marker gate is also written to the newly created EGE. That information is dynamically bound to its EGE in such a manner that it is always kept synchronized with updates to the gate's definition, as occurs, for example, when graphically moving or adjusting the boundaries of a gate.

Method 2: Typing or Pasting Part or all of an Expression String to a New Editable Row

In the embodiment of FIG. 2A, the user can create an editable worksheet row 202 by clicking on the “plus” symbol (shown at 208), typing or pasting an expression string into the Expression column 206 of that row, then double clicking any non-editable cell belonging to that row. This executes the gating expression and launches a graphics window housing graphs (such as a bivariate dotplot and a histogram) constructed from the filtered (gated) data (see below).

No action is taken when the user double-clicks on a worksheet row 202 bound to an SCE (e.g. worksheet row 204c in FIG. 2A).

Specifying and Executing a Gating Expression

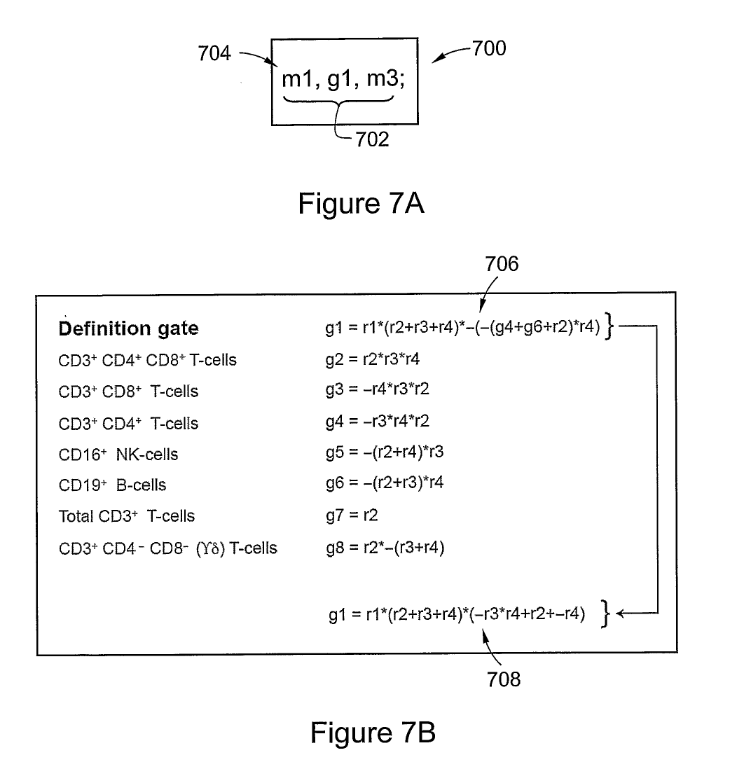

As discussed above, processing software defines a domain-familiar gating language in which gating procedures can be specified with text-based gating formulae referred to as “expressions”. A simple example of such an expression is shown at 700 in FIG. 7A; as may be seen in this example expression 700, an expression consists of one or plural process symbolic pointers 702, and (in this example) is terminated by a semi-colon. Process symbolic pointers reference the singular sub-setting actions of a marker gate “m” (such as marker gate m1 of expression 700) or a region gate “r”, or the plural sub-setting actions of a Boolean gate “g” (such as Boolean gate g1 of expression 700). There is no constraint on the number or order of region, marker or Boolean process symbolic pointers within an expression; that is, provided sufficient computing resources, the gating procedure will be executed correctly.

Flow cytometry data files typically contain a considerable number of data points that are due to particle contamination in the fluid used to carry the analyte (referred to as “sheath fluid” contamination) or electronic noise. Sheath fluid contamination is particularly problematic because its precise signature can drift from day-to-day operation of the flow cytometer, depending on such factors as the intrinsic quality of the sheath fluid, biological activity within the sheath fluid, and build up of contamination within the fluidics. Commonly, such noise is removed before the data relating to a particular sample is submitted to further gating steps. Different noise removal gates are used depending on the sample, yet the application of a particular noise removal gate may not require a change in any aspect of subsequently applied gates. That is, a different “pre-processing” gate or gates (in this example, the gate or gates removing sheath fluid noise) may often precede the same “definition” gates (gates which define a particular population from other populations within the set of non-noise data). With the expressions of processing software 114, system 100 allow the user to freely combine, in a single compact expression, any number of process symbolic pointers to singular and complex sub-gating expressions, and to build gating routines from “conceptual blocks”, thus providing a means to readily tailor an analysis, such as add, alter or exchange pre- or post-processing gates.

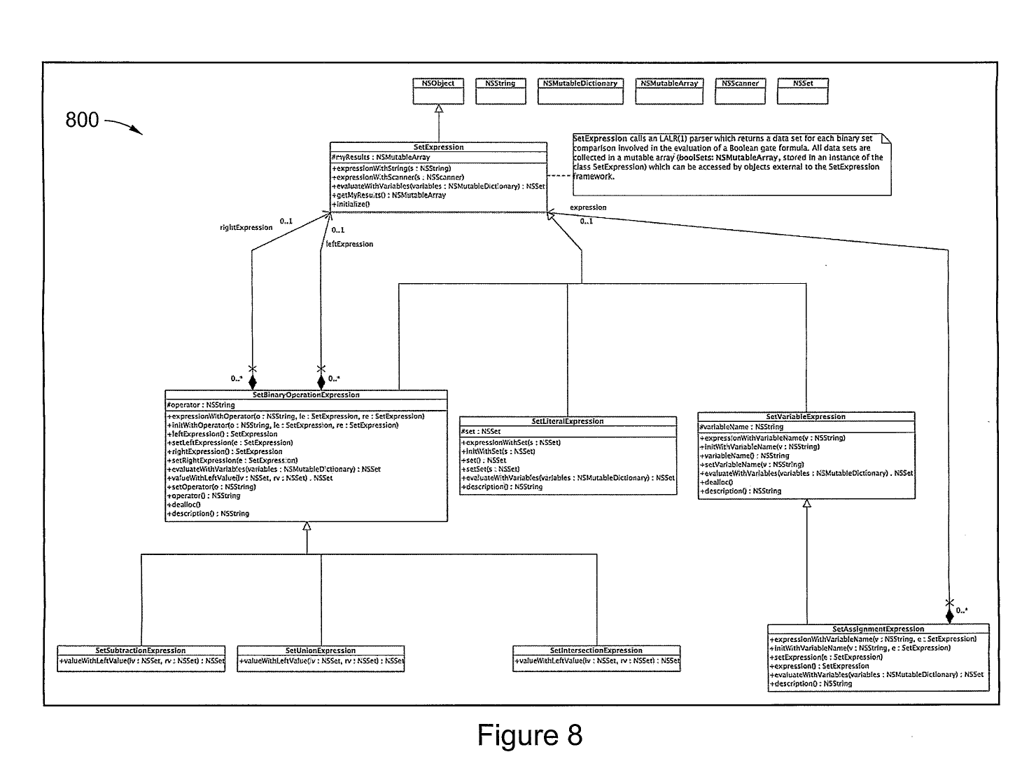

Execution of a gating expression proceeds as follows. When the user double clicks on a non-editable cell of any given worksheet row 202, processing software 114 checks whether the worksheet row maps a DFGE, EGE or SGE, according to the aforementioned classification rules for these entities. If the worksheet row maps a DFGE, double-clicking the row merely brings to focus or retrieves (if hidden from view) its associated graphics window. If the worksheet row maps an EGE, the contained expression (such as at 308 of FIG. 3) is parsed and executed. If the expression contains plural process symbolic pointers, these are separated from each other by a comma; such an expression thus represents a list of sequential sub-setting operations (derive a subset, then derive a subset from the resulting set, etc.), executed from left-to-right. Thus, expression 700 (i.e. “m1, g1, m3”) is executed as follows: the sub-setting operation referenced by the process symbolic pointer “g1” derives a subset from that data set resulting from the sub-setting operation referenced by the process symbolic pointer “m1”. This is then followed by the sub-setting operation referenced by the process symbolic pointer “m3”, which derives a subset from that data set resulting from the sub-setting operation referenced by the process symbolic pointer “g1”. Non-Boolean gating operations may be performed by any suitable, known technique, so are not described herein. Boolean gates, however, are evaluated via a SetExpression framework (summarized as UML class diagram 800 in FIG. 8), which returns a “solution” data set (i.e. the return set specified by the full Boolean equation) and “intermediate” data sets (those resulting from each binary set operation involved in the evaluation of the Boolean equation, described below). The solution data set is used as input to any further gating operations specified by the expression.

The input data file (i.e. the file that holds the data that is passed to first or singular sub-setting action specified by the expression) that is required to execute an EGE-associated expression is found from the contents of the Data File Path attribute (such as that shown at 304 in FIG. 3) of a DGFE possessing identical content in its Data File Alias attribute (such as that shown at 306 in FIG. 3). To obtain the appropriate information, processing software 114 searches the GEs rather than the actual worksheet rows 202 to which the GEs are dynamically bound.

This has the advantage that worksheet rows mapping DGFEs and EGEs may be vertically separated by any number of intervening rows within the worksheet with essentially no effect on operation of system 100, thus freeing the user to visually group worksheet rows as desired, such as in a manner that aids interpretation of his or her experimental results.

Entering, Simplifying and Evaluating Boolean Gate Formulae

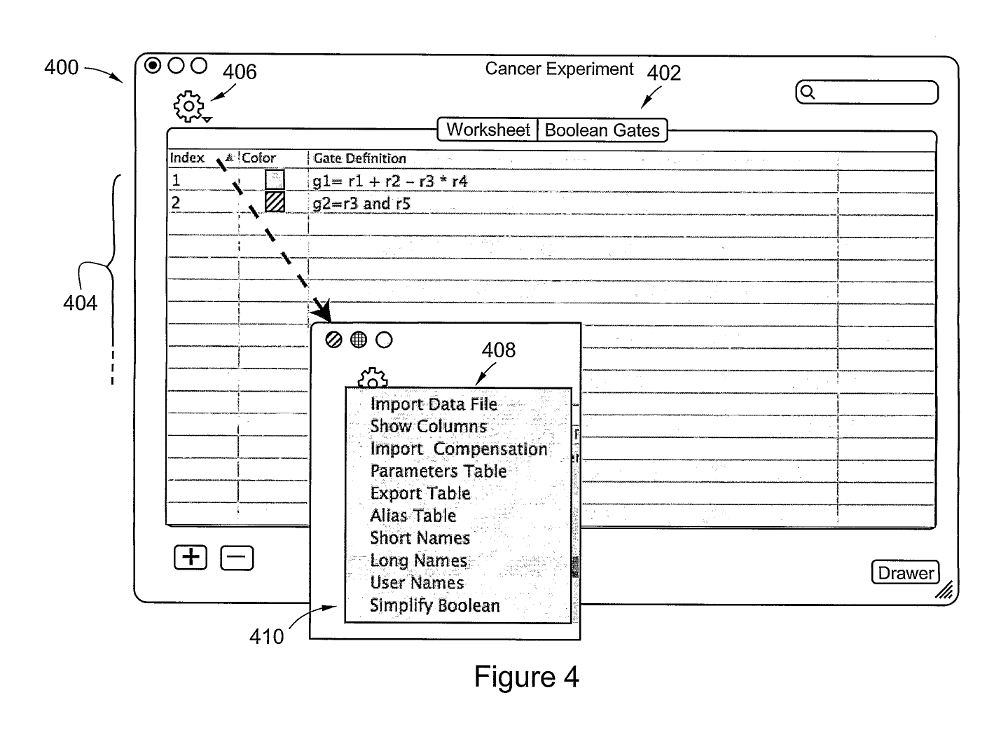

Processing software 114 is operable to display a Boolean Gates table on GUI 116; FIG. 4 is a view of an exemplary Boolean Gates table 400. (Boolean Gates table 400 can be displayed by clicking on Boolean Gates button 402.) Formulae for Boolean gates may be typed or pasted into the rows 404 of the Boolean Gates table 400. Boolean operators are specified as “and”, “or”, or “not”, or as “*” (and), “+” (or), or “-” (not). Processing software 114 automatically assigned the first Boolean gate the symbolic pointer “g1”; the number is incremented by one for all subsequently defined Boolean gates (g2, g3, g4, . . . , gn). Since Boolean gates may legally contain a reference to other Boolean gates, it is typically beneficial to simply a Boolean gate expression, as the time required to simplify a Boolean gate formula is usually justified by the time saved due to the evaluation of fewer binary set operations). The user effects that simplification by selecting the row 404 containing the Boolean gate to be simplified, then selecting—from Gear icon 406 popup menu 408—“Simplify Boolean” item 410. The expanded Boolean gate formula string is simplified using the Quine-McCluskey algorithm, and the simplified string replaces the original Boolean gate formula in the selected row. For example, FIG. 7B illustrates the simplification of an exemplary gate “g1” from an initial form 706 to a final, simplified form 708.

Boolean gate formulae in the Boolean Gates table 400 automatically populate a table attached to all graphics windows (see FIGS. 5A and 5B), from which it is possible to activate/deactivate a Boolean gate or gates, and toggle Boolean gate color on/off (as described above).

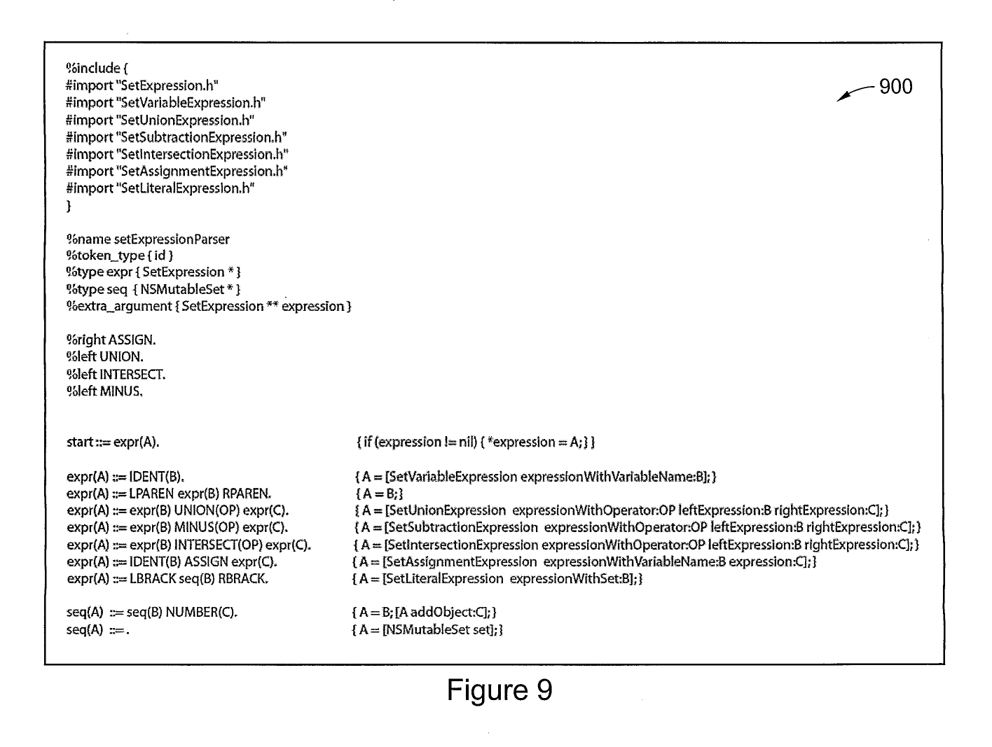

As mentioned above, evaluation of the Boolean formulae is handled with a SetExpression framework, summarized herein by UML class diagram 800 in FIG. 8. SetExpression represents the master class in respect both of the operation of the framework 800 and of the interaction of the framework with Boolean gate formulae passed to it. For each Boolean gate formula, SetExpression scans and tokenizes the formula string and forwards a token stream to an LALR(1) parser (whose grammar specification is shown at 900 in FIG. 9). The LALR(1) parser returns a data set for each “intermediate” binary set comparison involved in the evaluation of Boolean gate formulae, as well as the final “solution” data set. All data sets are collected in a mutable array boolSets: NSMutableArray, stored in an instance of the class SetExpression (cf. FIG. 8), which can be accessed by objects external to the SetExpression framework 800.

The solution data set is used as input to any further gating operations that may be specified by an expression. For example, within the “big cells” expression in worksheet row 204d of FIG. 2A, the solution data set for “g1” is passed as input to the singular sub-setting action, “m1”.

System-wide Scriptability

System-wide scriptability allows the user to build scripts for dynamically interrogating information residing internally (e.g. in other persistent documents created by the invention) or externally (i.e. in files created by other applications). This assists the user to maintain analysis quality without relying on the visual inspection of each input and output data set and associated statistics (mean, median etc. calculated as a result of the manual gating operations). The information can then be used as input to a quality control test for the purpose of amending, pausing or recommencing a gating procedure or procedures, or a batch processing routine or routines during an analysis session. For example, the user can build and execute a script that compares the results of executing expressions on a particular experimental batch of data files to results of those same expressions executed on a control batch, and control system 100 to generate appropriate warnings and graphs for the purpose of amending the analysis of a given data file or files during an analysis session. This eliminates any need to visually monitor the entire analysis process, resulting in time savings.

The processing software 114 exposes flow cytometry data analysis functionality (including intermediate gating actions that form part of a Boolean gate) to system-wide scriptability, by (a) providing the user the ability to define gate and expression aliases, and (b) adapting processing software 114 for Open Scripting Architecture (OSA)-compliant scriptability.

a) User-defined aliases for “expressions”, “gates” and intermediate Boolean operations

To allow the user to reference (or “call”) a resulting data set (and associated statistics) of any gating operation by name in an OSA-compliant script (see below), the user can define an alias for an expression and for any operation that is referenced by (i.e. contained within) an expression or Boolean gate formula. For operations contained within expressions and Boolean gates formulae, plural aliases may be specified, one alias per operation.

To specify an alias for an expression, the user types or pastes the alias string (e.g. “big cells” shown at 210 in FIG. 2A) into the “Expression Alias” column (212 in FIG. 2A) of worksheet table 200, adjacent to the expression (214 in FIG. 2A) that he or she wishes to reference, thus replacing the default alias (automatically set to the expression string).

The user can specify an alias for a process symbolic pointer contained within an expression by selecting the worksheet row 202 containing the expression and then selecting Gear Icon 216 >Alias Table 218 to launch an “Alias Table” 220. Alias table 220 that appears is automatically populated with the component operations of the selected expression. The user can then type or paste an alias (e.g. “leucocytes” at 222 in Alias table 220) opposite one or more of the component operations, thus replacing the default alias (automatically set to the process symbolic pointer) for that operation.

The user can specify an alias for an “intermediate” data set resulting from a binary set comparison returned during the evaluation of a Boolean gate by double-clicking on the name cell (e.g. 222 in Alias table 220) of the row containing the Boolean gate alias; this prompts a new table 224 to be displayed, which is automatically populated with strings describing each binary set comparison that was involved in the evaluation of a given Boolean gate formula. The user can type or paste a string adjacent to that binary set comparison desired to alias by name (e.g. “leucA” at 226 in table 224 of FIG. 2A). Furthermore, “delete” checkbox 228 in table 224 of FIG. 2A allows the user to direct system 100 to delete (i.e. specify that it should not be retained in memory) any or all data sets resulting from those binary set comparisons listed in table 224, thus providing a simple mechanism for controlling memory resources consumed by the temporary storage of those data sets.

b) OSA-Compliant Scriptability

The OSA provides a standard and extensible mechanism for interapplication communication in Macintosh OS X. Communication takes place through the exchange of Apple events (trade mark), a type of message designed to encapsulate commands and data of any complexity. Apple events provide an event dispatching and data transport mechanism that can be used within a single application, between applications on the same computer, and between applications on different computers. The OSA defines data structures, a set of common terms, and a library of functions, so that applications can more easily create and send Apple events, as well as receive them and extract data from them.

The OSA supports several features in Macintosh OS X:
the ability to create scriptable applications;
the ability for users to write scripts that combine operations from multiple scriptable applications;
the ability to communicate between applications with Apple events; and
the ability to support multiple scripting languages.

To provide maximum OSA-compliant scriptability, system 100 implements the Apple Cocoa (trade mark) document architecture, key-value coding (KVC) compliant accessor methods for scriptable properties and elements, provides a scripting definition (sdef) file, and Object Specifier methods for scriptable classes in an application's object model.

In common with other applications that use OSA technology to expose key methods to system-wide scriptability, processing software 114 supports statements that manipulate the objects in the application's scriptable object model. The part of a OSA-compliant script statement that identifies an object, such as first document, is called a reference. A reference rarely occurs in isolation; usually a script statement consists of a series of references, preceded by a command and typically connected to each other by “in” or “of”.

An Apple event encapsulates the operation specified by an OSA-compliant script statement and delivers it to the application. For Apple events that correspond to commands defined in the application's sdef file, Cocoa scripting converts the Apple event into a script command that contains all the information necessary to perform the operation.

To describe the objects specified by a reference, the command uses object specifiers. Where a OSA-compliant script statement identifiers an object in the invention's scriptable object model, an object specifier identifies the corresponding object in the application itself. When the application must return an object to the calling script, Cocoa scripting also uses an object specifier, supplied by the invention, to identify the object.

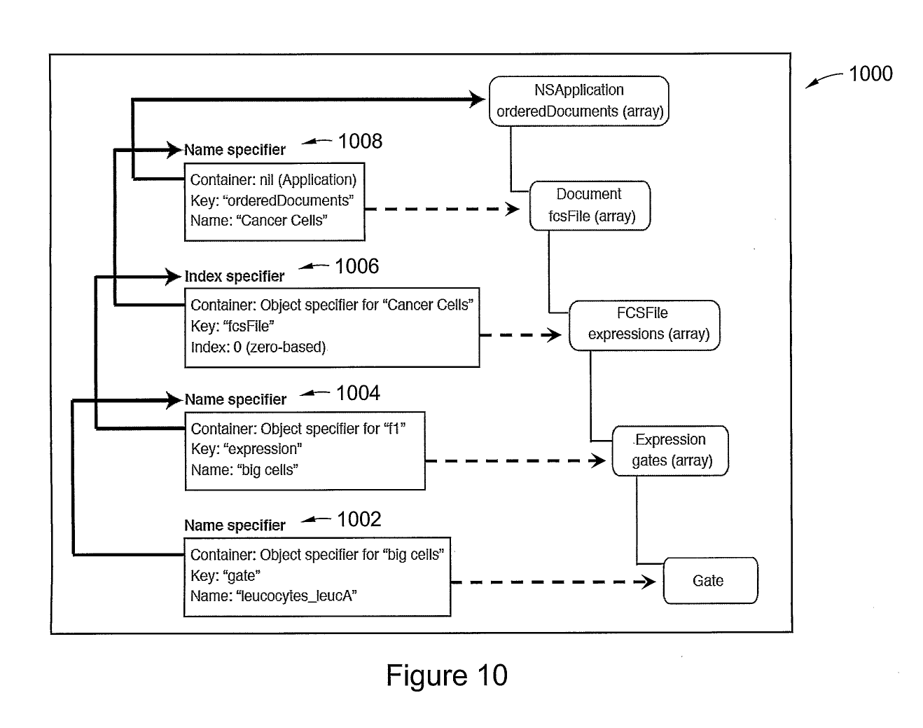

FIG. 10 depicts schematically the Nested Object Specifiers 1000 that facilitate reference of a gate object via an OSA-compliant script, and hence how processing software 114 provides a series of nested object specifiers for a gate object, so that OSA-compliant script statements can be used to obtain a reference to the resulting data set of any gating operation. This is so irrespective of the position of a particular sub-setting action in a sequence of such actions, and irrespective of whether the resulting data set originates from a singular or complex sub-setting action, and including any “intermediate” data set resulting from binary set comparisons returned during the evaluation of a Boolean gate.

In the following discussion, the OSA-compliant script statement “get gate ‘leucocytes_leucA’ of expression ‘big cells’ of fcsFile 1 of document ‘Cancer Experiment’” is referred to.

1. A name specifier 1002 specifies the alias of a symbolic pointer mapping a singular or complex (Boolean gate) sub-setting action, which is an object of class Gate. The specifier has these components:
The name for the specified object, which in the above example has the value “leucocytes_leucA”. The name may optionally refer to the alias of an intermediate Boolean binary operation, using the syntax alias of Boolean gate_binary operation alias. Thus “leucocytes_leucA” refers to that data set resulting from a Boolean binary operation named by the alias leucA, which is returned during evaluation of the Boolean gate name by the alias leucocytes.
A key that specifies the collection for the specified object, which in the above example has the value “gate”.
A container reference that specifies the parent for this object specifier. In the above example, the container is the object specifier for the expression “big cells”.

2. A name specifier 1004 specifies the alias of an expression, which is an object of class Expression. The specifier has these components:
The name for the specified object, which in the above example has the value “big cells”.
A key that specifies the collection for the specified object, which in the above example has the value “expression”.
A container reference that specifies the parent for this object specifier. In the above example, the container is the object specifier for the FCS file “f1”.

3. An index specifier 1006 specifies the file number specified within the alias of an FCS file, which is an object of class FCSFile. In the above example, 1 refers to the FCS file given the alias “f1”, 2 refers to the FCS file given the alias “f1”, . . . , n refers to the FCS file given the alias “fn”. The specifier has these components:
The index for the specified object, which in this example has the value 0. This is the zero-based index of the specified FCS file in its containing array.
A key that specifies the collection for the specified object, which in the example has the value “fcsFile”. The fcsFile array is the collection for the indexed object.
A container reference that specifies the parent for this object specifier. In this example, the container is the object specifier for the document “Cancer Cells”.

4. A name specifier specifies the document containing the gate object, which is an object of class Document. The specifier has these components:
The name for the specified object, which in this example has the value “Cancer Cells”.
A key that specifies the collection for the specified object, which in the above example has the value “orderedDocuments”. The application's ordered array of documents is the collection for the named document, though in this case, the order is unimportant.
A container reference that specifies the parent for this object specifier. In the example, the reference is nil, specifying that the array of documents is contained by the application object.

Modifications within the scope of the invention may be readily effected by those skilled in the art. It is to be understood, therefore, that this invention is not limited to the particular embodiments described by way of example hereinabove.

In the preceding description of the invention and in the following claims, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in Australia or any other country.

What is claimed is:

1. A computer-implemented method of processing flow cytometry data, comprising:
inputting or receiving an alphanumeric expression comprising at least one process pointer, indicative of a gating process, a Boolean process or an external process;
parsing said expression;
executing said process indicated by said process pointer on multivariate flow cytometry data in a data file; and
outputting output data comprising said multivariate data processed according to said expression.

2. A method as claimed in claim 1, including associating said alphanumeric expression with said data file.

3. A method as claimed in claim 2, including inputting in said alphanumeric expression at least one data file pointer indicative of said data file.

4. A method as claimed in claim 3, including separating said data file pointer from said at least one process pointer with an alphanumeric character.

5. A method as claimed in claim 3, including entering said data file pointer and said at least one process pointer in separate fields of a user interface.

6. (canceled)

7. (canceled)

8. A method as claimed in claim 6, including displaying an indicium indicative of said data file and said alphanumeric expression as a tree, said data file being displayed at a node of said tree and said alphanumeric expression being displayed inferior to said node.

9. A method as claimed in claim 6, wherein a plurality of data files are each associated with one or more respective alphanumeric expressions, and said method includes displaying respective indicia indicative of said data files and said alphanumeric expressions as a tree, each of said data files being displayed at respective nodes of said tree and each of said alphanumeric expressions being displayed inferior to the respective node of its corresponding data file.

10. A method as claimed in claim 1, including inputting a plurality of alphanumeric expressions in respective data entry fields visually associated with respective data file indicia, each indicative of a respective data file of multivariate data.

11. A method as claimed in claim 1, wherein said expression comprises a plurality of data file pointers, each indicative of a respective data file of multivariate data to be processed by said process indicated by said process pointer.

12. (canceled)

13. A method as claimed in claim 1, wherein said expression includes at least one watch point for initiating testing of a predefined condition, and indicated in said expression relative to one or more process pointers.

14. A method as claimed in claim 13, including responding when said condition yields true by continuing to evaluate said expression without user interaction, and responding when said condition yields false by performing a predefined response.

15. A method as claimed in claim 1, wherein, when said alphanumeric expression is indicative of one or more Boolean processes, parsing said alphanumeric expression includes at least one returning intermedia result set, and outputting said intermedia result set or making said intermedia result set available to a user.

16. A system for processing flow cytometry data, comprising:
an input for receiving an alphanumeric expression comprising at least one process pointer, indicative of a gating process, a Boolean process or an external process;
a parsing module for parsing said expression;
a processor for evaluating said expression by executing said process indicated by said process pointer on multivariate flow cytometry data in said data file; and
an output for outputting data comprising said multivariate data processed according to said expression.

17. A system as claimed in claim 16, including a mechanism for associating said alphanumeric expression with said data file.

18. A system as claimed in claim 17, wherein said input is configured to receive in said alphanumeric expression at least one data file pointer indicative of said data file.

19. A system as claimed in claim 17, wherein said input includes a display and is configured to provide a data entry field for receiving said alphanumeric expression, said data entry field being associated in said display with a data file indicium indicative of said data file.

20. (canceled)

21. A system as claimed in claim 16, wherein, when said alphanumeric expression is indicative of one or more Boolean processes, parsing said alphanumeric expression includes at least one returning intermedia result set, and outputting said intermedia result set or making said intermedia result set available to a user.

22. A computer-implemented method of processing flow cytometry data, comprising:
inputting into a first computing device an alphanumeric expression comprising at least one process pointer, indicative of a gating process, a Boolean process or an external process;
electronically dispatching said expression to a second computing device;
receiving from said second computing device response data comprising multivariate data processed according to said expression once parsed by said execution of said process indicated by said process pointer on original multivariate flow cytometry data in a data file ; and
outputting response data.

23. A method as claimed in claim 22, including associating said alphanumeric expression with said data file of said original multivariate data.

24. (canceled)

25. A computer readable medium provided with program data that, when executed on a computing device or system, controls said device or system to perform said method according to claim 1.
